(19) United States
(12) Patent Application Publication
(10) Pub. No.: US 2007/0186274 A1
(43) Pub. Date: Aug. 9, 2007

(54) Zone based security model

(75) Inventors: Michel Thrysoe, Storvorde (DK); Jinhong Guo, West Windsor, NJ (US); Stephen Johnson, Erdenheim, PA (US); Il-Pyung Park, Princeton Junction, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/348,882

(22) Filed: Feb. 7, 2006

(51) Int. Cl. H04L 9/32

(52) U.S. Cl. 726/2

(57) ABSTRACT

An access control method includes dividing a data processing system into multiple zones. Memberships of processes and objects in the zones are identified, and internal relationships between the zones are defined. The relationships between the zones are used to grant or deny processes access to objects based on their memberships in the zones and positions of the processes in the zones.

### FIELD OF THE INVENTION

The present invention generally relates to data processing system access control, and relates in particular to a zone based access control method.

### BACKGROUND OF THE INVENTION

Access control is a key point in the security of any operating system and if the system is compromised, it is the last way to contain the attacker. Traditionally, on the Unix type of systems based on a DAC model, the user ID of the owner is used to mediate access to file objects. However, as the number of attacks on systems has increased, this model has proven no longer to be sufficient. To compensate for this situation, many new models have been proposed, the most famous of which is the Mandatory Access Control (MAC) model in which access permissions are based on the sensitivity of each object according to the security policies.

Others have been exploring different access control mechanisms. One example is the Medusa DS9 project that implements MAC by using a virtual space model, where a virtual space grants access to a resource and access to the virtual space is enforced by an access vector placed on objects and subjects in the system. Also, Security-Enhanced Linux (SELinux) was developed by NSA and is native in the vanilla Linux kernel source; the system implements several different MAC schemes, including type enforcement, and has the ability to exchange the security decision-making code to implement another scheme. SELinux is based on Linux Security Modules (LSM).

Domain and Type Enforcement (DTE) is an enhanced version of type enforcement designed to simplify the configuration process of type enforcement systems. DTE improves the regular type enforcement in two ways: DTE policies are expressed in a high-level language, including security attribute configuration, and during system execution DTE attributes are maintained using a concise human readable format.

By itself, the LSM does not provide any additional security. It adds void security fields to kernel objects and framework of security hooks to mediate access to these objects. It is the base of many security systems for Linux including SE-Linux, Digsig, RSBAC, LIDS, and the Umbrella Project.

What is needed is a system access control model that is easier to configure and has a more adequate granularity to protect the system in cases where the normal DAC model has failed or simply is not applied. The present invention fulfills this need.

### SUMMARY OF THE INVENTION

In accordance with the present invention, an access control method includes dividing a data processing system into multiple zones. Memberships of processes and objects in the zones are identified, and internal relationships between the zones are defined. The relationships between the zones are used to grant or deny processes access to objects based on their memberships in the zones.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating division of a simple system into multiple, overlapping zones in accordance with the present invention;

FIG. 2A is a block diagram illustrating moving of processes between zones in accordance with the present invention;

FIG. 2B, is a block diagram illustrating demotion of a process to an intersection between two zones in accordance with the present invention;

FIG. 2C is a block diagram illustrating movement of a process from an intersection to a new zone in accordance with the present invention; and

FIG. 2D is a block diagram illustrating merging of two zones for a subject located in an intersection in accordance with the present invention.

### DETAILED DESCRIPTION OF THE PREFERRED EMBODIMENTS

The following description of the preferred embodiments is merely exemplary in nature and is in no way intended to limit the invention, its application, or uses.

A presently preferred embodiment provides a “Zone Based” security model (ZB) that is easily configurable and has adequate granularity to fight most of the usual security threats found in devices today, such as CE devices. The ZB model can be used as a replacement for the traditional DAC model or in combination with DAC to provide an even finer granularity.

In the ZB model all entities (subjects/objects) are located in zero, one or more zones. The access control decisions are based upon membership of these zones and the internal relationship between the zones. Furthermore, the internal relationship between the zones is specified asymmetrically in a “Zone Relation Matrix” (ZRM). This matrix allows the system to have differentiated read, write and execute access to objects located in zones based on the origin of the request. The ZRM matrix is also used to specify in which zone newly created processes are placed based on their parents location and the object, if any, from which they were created. Thus, an inheritance mechanism is effectively created in which newly created children potentially are more restricted than their parents, depending on how they are spawned. Because overlapping zones are allowed, access to objects in the border areas can be monitored to determine if write access was granted and from where. This information can later be used to determine if a process accessing the object must be moved from a zone to the intersection area between two zones, as potential security problems may exist. This “transition” mechanism is referred to as the “Zone Transition Mechanism” (ZTM). To allow system components like “login” and “ssh” to function properly, the ZTM supports granting tokens to processes allowing them to move from a zone intersection into one of the zones creating the intersection.

The concept of a “Zone Based” security model is based on the idea that it is possible to separate the system into individual segments, referred to herein as “Zones”, and calculate subject to object access permissions based upon predefined interactions between the zones and their zone placement.

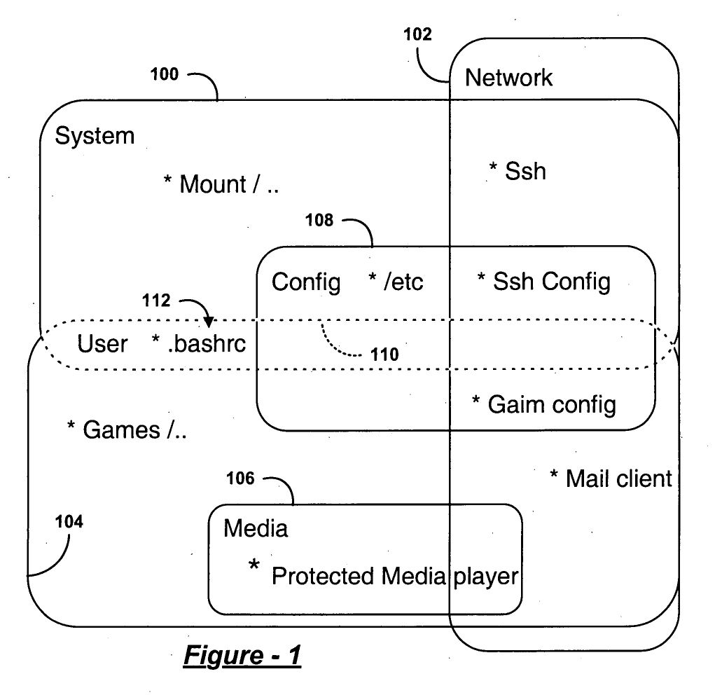

Referring to FIG. 1, a system can be divided into the following zones: System zone 100, Network zone 102, User zone 104, Media zone 106, and Config zone 108. However, it is envisioned that various other types of zones and any number of zones are possible. Each of the zones can represent an area of the system that is logically connected in some way. Each entity on the system can be allowed to be a member of one or more zones, thereby creating the sense of a multi-layered model. For example, the system zone 100 and user zone 104, which have overlapping regions, can create as a result of their overlap a third zone, system/user zone 110, with the security profile of both zones. This approach can enable a system process reading user supplied data, like the .bashrc file object 112, to be moved from the system zone 100 to the combined system/user zone 110, where restrictions can be placed on it's ability to communicate with the rest of the system zone 100. Furthermore, a token can be granted to the process allowing it to move to the user zone 104 if permitted by the system zone 100.

Another interesting example zone is the media zone 106. It is located within the user zone 104, meaning that it is placed in the same part of the file system as the user zone 104. However, being an individual zone makes it possible for it to be separate from the rest of the user zone 104 by specifying strict rules for communication with other parts of the user zone 104 area.

A zone definition language can be employed for configuration purposes. For example, to setup the zone relationships, a simple configuration language can be used to specify the relationships between the zones and specify how to handle transitions between the zones. More specifically, the language can define access permissions, such as read, write and execute capabilities, between subjects and objects and subject to subject relationships between processes when the processes are located in overlapping areas. Listed below is an example of a structure of such a language, but it should be readily understood that this listing provides an example language, and that various embodiments of such a language can be employed.

```
Zone (System) {
  path:
    /bin, /sbin ...
  out:
    config:
object: r,w,x,
subject: signals, socket, pipes, ipc
    network:
object: r,w,x
...
    user:
...
  in:
    user:
object: r,x
subject: signals, socket,pipes,ipc
    network:
      ...
    config:
      ...
  transition:
    config
  allow_incoming:
    system, user: r
}
```

The language used can be able to specify the paths contained within the zone and the read, write and execute permissions for incoming and outgoing communication for the zone. Generally the outgoing specifications are useful when calculating access permissions for a process in a zone accessing an object located within another zone. Similarly, the incoming specifications can be used to set capabilities on processes from other zones trying to access objects in a zone. Both the outgoing and incoming sections can specify subject to object and subject to subject access within zone intersections. A transition section can define zones from which processes are allowed to change into this zone. Allow incoming can specify whether cross zone boundary reads are permitted from processes located in an intersection area between two zones. In case of multilayered zones, a negative can always count more than positive.

A zone relation matrix can be used by access control decision processes. For example, configuration files can be used to create a “Zone Relation Matrix” for making access control decisions. The following example of matrix entry calculations illustrates the type of information that can be needed to calculate access control information between subjects located in a System zone and objects in a User zone.

```
Zone(System) {
...
  out:
    User: r,w,x
...
}
Zone(User) {
  in:
    System: r,w
```

Each entry in the matrix table or other data structure can be calculated by using an intersection between an out field in a subject's zone and an in field of the object's zone. The result of the example provided directly above is an access control policy containing Read and Write capabilities. Additionally, information about subject to subject access, cross zone boundary access, and zone transformation rules can be obtained in calculating the asymmetrical relationship between zones defined by the configuration file. An example of such a matrix can be seen in Table 1. The information on transformation and boundary crossing are not included in the example matrix.

TABLE 1
Zone Relation Table

| In/Out | System | User | Config | Net | Media |
|---|---|---|---|---|---|
| System | N/A | Rx | R | R | — |
| User | Rwx | N/A | R | R | — |
| Config | Rw | Rw | N/A | rw | — |
| Net | Rw | R | R | N/A | — |
| Media | — | — | — | — | N/A |

The matrix in Table 1 shows the internal subject to objects relationship between the zones in the system. The matrix can be used during runtime not only to lookup the relationship between two zones, but also as a base for calculating access control policies in cases where an area is covered by multiple zones. An example access grant decision process is provided below.

```
// Write access to a file located in
  // system/inet/config from system
  system -> inet = rw
  system -> config = rw
  system -> system = rwx
  system -> system/inet/config = rw
```

In the above access grant decision example, a process located in the system zone wants to open a file located in the system/inet/config zone with write permissions. The system checks the relationship between each of the zones involved and then combines the result. In this example, access is granted because all zones involved allow write access from system. In this example, the system zone has read/write capabilities to most of the system, thereby allowing system tools to edit configuration files located in the internet zone. An access denial decision example is provided below.

```
// Write access to a file located in
  // system/inet/config from user
  user -> inet = r
  user -> config = rx
  user -> system = rw
  user -> system/inet/config = r
```

The above access denial decision example results in an access denial decision because, in contrast to the access grant decision example, write access from the User zone is not permitted in the network and config zones.

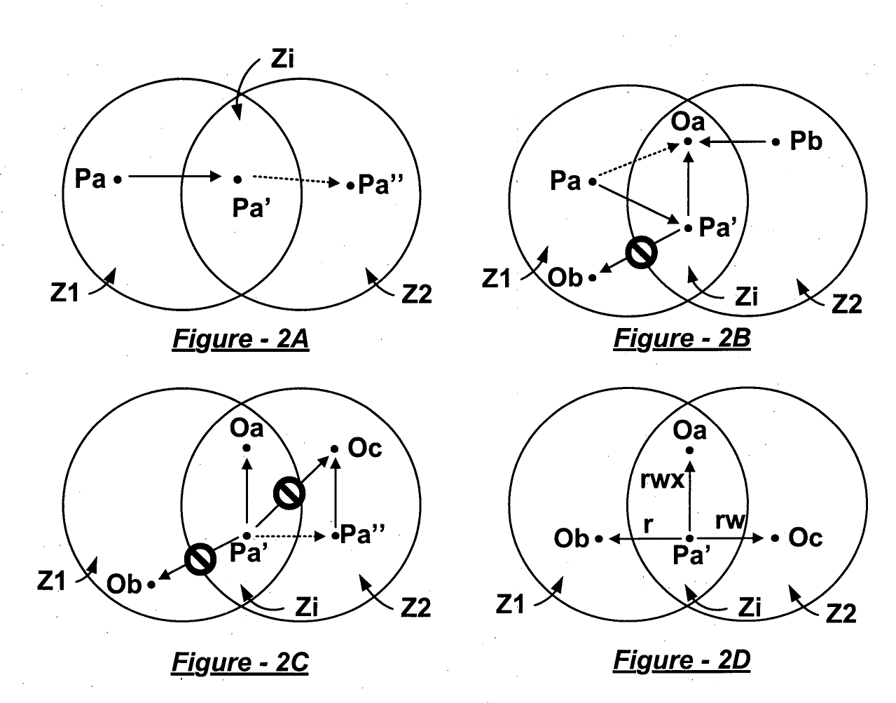

Turning now to FIGS. 2A-2D, access of a process to objects can be governed by a subject zone transformation process. For example, membership of a process can move from an intersection zone Zi created by overlap of a first zone Z1 and a second zone Z2. The identity of a process can in some respects be considered a function of its membership in a particular zone. Thus, movement of the membership of the process from one zone to another can be viewed as changing the process into a new process. This movement and change mechanism can be implemented in various ways.

Referring now to FIG. 2A, subject zone transformation involves the moving of a process from one zone to another. For example, process Pa can move from first zone Z1 to intersection zone Zi and become process Pa′. Then, process Pa′ can move from intersection zone Zi to second zone Z2 and become process Pa″. In order for programs like login and ssh to function properly and still have enough control to secure the system, it is useful to be able to move processes from one zone to another. The system can contain three different options for changing a process's zone relationship: intersection placement, zone shifting, and zone merge.

In the case of ssh, the system creates a child when receiving an incoming connection. This child must be able to relocate to function properly. One example is when a user uses ssh to login, the sshd daemon creates a child sh that reads the user's shell profile file. This read should move the child from the system zone in which sshd is located, into an intersection zone between system and user. The child can then be moved completely to the user zone if necessary.

Referring now to FIG. 2B, intersection placement of processes can be useful for avoiding some potential problems. For example, intersection placement can avoid situations where user supplied data can be used to corrupt processes across zone boundaries by injecting corrupted data into objects located in the intersection areas. To prevent this situation, processes reading files previously accessed in write mode by subjects from other zones can be moved into the intersection area between the two zones in order to control their behavior after reading the data.

By way of example, in a simple system containing two processes and two objects divided into first zone Z1 and second zone Z2 overlapping to form intersection zone Zi, process Pb located in second zone Z2 writes data to object Oa located in the intersection zone Zi. The object is marked as being written to by Pb. Process Pa in first zone Z1 attempts to read access Oa and finds it marked by another zone. Pa is moved into the intersection zone Zi and becomes Pa′ to allow access to Oa. Pa is now able to access Oa and reads the data. Pa′ can then try to access Ob in first zone Zi, but can be prevented from doing so by the rules set up in the ZRM.

Referring now to FIG. 2C, zone shift can occur when, as and if specified in the configuration file, processes located within intersection areas, such as intersection zone Zi, are allowed to move from there into one of the intersecting zones, such as first zone Z1 or second zone Z2. This move can be accomplished by assigning processes a token allowing them to pass into other zones on creation or on being placed in an intersection area.

By way of example, process Pa′ in intersection zone Zi can attempt to access object Ob located within first zone Z1, but cannot access based on the rules specified for the intersection zone Zi. The process Pa′ does not have a valid token to move from the intersection zone Zi into the first zone Z1, so access to the object Ob is not permitted. Access to object Oa from process Pa′ is always permitted. If Pa′ at some point tries to access an object located in the second zone Z2, the process Pa′ is again asked for a token allowing it to pass the zone barrier between the intersection zone Zi and the second zone Z2. If such a token exists, Pa′ is allowed to use it to move into the second zone Z2 and to become Pa″. Once the token is used, it is removed to prevent situations where processes are allowed to move between zones all the time. When Pa″ is located in the second zone Z2, access to object Oc is permitted, but access to the intersection zone Zi is calculated based on the rules specified in the configuration file.

Turning now to FIG. 2D, asynchronous zone merge is a technique by which, as and if specified in the zone configuration file, a process can be allowed to obtain permissions to interact with an entire area covered by interacting zones. This kind of behavior can be useful for processes like syslogd, which require read access to most of the system, but only require write access to a very limited part of the system.

By way of example, process Pa′ was originally placed in first zone Zi as process Pa, but was moved into the intersection zone Zi because of access to a tainted object in the intersection zone Zi. The rules set up in the ZMT limit the access from the intersection zone Zi to the first zone to read only. However, because Pa′ originally came from the first zone Z1, it has no immediate access to objects located outside the intersection zone Zi in a second zone Z2 unless it is specified in the second zone's definition that first zone processes located within the intersection area between the first and second zones are allowed access under a given set of rules. This asynchronous relationship is reflected in that Pa′ has full access to objects within the intersection zone Zi and only read access to objects in the first zone Z1 because of the rules specified for zone interaction in the definition. The read/write relationship for Pa′ to the second zone Z2 can be found in the incoming section of the second zone's configuration.

This technique can allow a zone to be created for syslogd containing only the executable file itself and the path to the log file (e.g., /var/log/messagesl). Then, it can be specified in the configuration file that processes from the syslogd zone are allowed read access to most of the other zones in the system, while only having write access to the log directory, and preventing any processes from zone shifting. This specification can prevent attacks on the syslogd from having any serious effects, since write access is only possible in non-critical areas. Furthermore, information leakage can be minimized by preventing most zones from accessing the syslogd zone, as most of them have no need to do so. It should be readily understood that the forgoing example demonstrates only one of many embodiments. For example, this type of behavior can be used to control media players, etc.

Subject to subject communication can be supported that avoids compromising system security. For example, to prevent situations where common system activities, like inter-process communication (IPC), signaling, pipes, and creating sockets, can be used to compromise system security, control of these features can be integrated into the security system. To handle these types of situations, the ZBS module can allow the capability of processes to use these kinds of features to be limited.

IPC is a commonly used feature to exchange information between related processes in Unix based systems using, for example, shared memory area. If two processes are placed in different zones, this feature could potentially be used to pass malicious content between zones, thereby gaining the ability to hijack a process in another zone. However, IPC can be handled in a secure fashion. For example, the ZBS module can be configured to always allow IPC between processes located within the same zone, because compromising a process in the same zone would not lead to additional privileges. IPC communication across zone boundaries can also be allowed, if this permission is specified in the ZMT for that specific zone. However, to secure the system against cross boundary hijacking, the processes receiving the IPC can be placed in an intersection area between the two zones, where access to the rest of the zones is restricted. If IPC communication between two zones is not noted in the system, it can be prevented. Like IPC, pipes are commonly used in Unix systems to pass information from process A to process B and, therefore, the same rules can apply for pipes as for IPC.

Sending of signals in the system can also be handled in a secure fashion. For example, to protect the system against DoS type of attacks using signals from unknown software, sending signals across zone boundaries can be disallowed by default. Therefore, if it is specified in the ZMT that signaling is allowed between two zones, no further mediation need be performed.

Socket creation can further be handled in a secure fashion. For example, to allow ZBS to create a sandbox type of zone where access to system resources and outside communication is limited, it is possible to prevent socket creation within zones and to place restrictions on socket creation within zone intersection areas.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An access control method, comprising:
dividing a data processing system into multiple zones;
identifying memberships of processes and objects in the zones;
defining internal relationships between the zones; and
using the relationships between the zones to grant or deny processes access to objects based on memberships of the processes and objects in the zones.

2. The method of claim 1, further comprising specifying internal relationships between the zones asymmetrically in a data structure, thereby allowing the system to have a differentiated set of access to objects located in zone intersection areas based on an origin of a request.

3. The method of claim 2, further comprising using the data structure to specify in which zone newly created processes are placed based on their parents' location or locations and an object, if any, from which they were created.

4. The method of claim 2, further comprising calculating one or more entries in the data structure by using an intersection between an out field in a subject's zone and an in field of an object's zone.

5. The method of claim 2, further comprising using the data structure to specify subject to subject access.

6. The method of claim 2, further comprising using the data structure to specify cross zone boundary access.

7. The method of claim 2, further comprising using the data structure to specify zone transformation rules.

8. The method of claim 1, wherein one or more zones overlap to create one or more zone intersections, further comprising monitoring access to objects in zone intersections to determine if access permission has been granted and from where.

9. The method of claim 8, further comprising determining if a process accessing an object must be moved from a zone to a zone intersection between two zones based on results of the monitoring.

10. The method of claim 1, wherein one or more zones overlap to create a zone intersection, further comprising granting tokens to processes allowing them to move from the zone intersection into one of the zones creating the intersection.

11. The method of claim 1, further comprising employing an asynchronous zone merge technique by which, if specified in a zone configuration file, a process can be allowed to obtain permissions to interact with an entire area covered by interacting zones.

12. The method of claim 1, further comprising employing a zone definition language to accomplish system configuration by specifying the zones.

13. The method of claim 12, further comprising using the configuration language to specify the relationships between the zones and specify how to handle transitions between the zones.

14. The method of claim 12, wherein one or more zones overlap to create one or more overlapping areas, further comprising using the configuration language to define access permissions between subjects and objects and subject to subject relationships between processes when the processes are located in one or more of the overlapping areas.

15. The method of claim 12, further comprising using the configuration language to specify paths contained within a zone and access permissions for incoming and outgoing communication for the zone.

16. The method of claim 15, further comprising employing outgoing specifications when calculating access permissions for a process in one zone accessing an object located within another zone.

17. The method of claim 15, further comprising employing incoming specifications to set capabilities on processes from other zones trying to access objects in a zone.

18. The method of claim 15, further comprising employing outgoing and incoming sections of a zone specification to specify subject to object and subject to subject access within zone intersections.

19. The method of claim 12, further comprising using the configuration language to specify a zone by indicating zones from which processes are allowed to change into the zone being specified.

20. The method of claim 12, wherein one or more zones overlap to create one or more intersection areas, further comprising using the configuration language to specify whether cross zone boundary accesses are permitted from processes located in an intersection area between two zones.

21. The method of claim 1, further comprising calculating subject to object access permissions based upon predefined interactions between the zones and a subject's zone placement.

22. The method of claim 21, further comprising creating, as a result of overlap between two zones, a third zone having a security profile reflecting the security profiles of the zones that overlap.
